(19) United States
(12) Patent Application Publication
(10) Pub. No.: US 2025/0040531 A1
(43) Pub. Date: Feb. 6, 2025

(54) INSECT PEST DETECTION SYSTEM AND ASSOCIATED METHOD

(71) Applicant: BERKEM DEVELOPPEMENT, BLANQUEFORT (FR)

(72) Inventors: Olivier FAHY, BORDEAUX (FR); Daouia MESSAOUDI, SAINT-PRIESST (FR); Mathias BOUTIN, BLANQUEFORT (FR); Eric MOUSSU, BLANQUEFORT (FR)

(21) Appl. No.: 18/485,525

(22) Filed: Oct. 12, 2023

(30) Foreign Application Priority Data
Aug. 1, 2023 (EP) 23189063.3

(51) Int. Cl. A01M 1/02; G01N 27/22

(52) U.S. Cl. CPC A01M 1/026; G01N 27/226

(57) ABSTRACT

An insect pest detection system including a group of underground boxes having a housing for at least one mass of edible material and a device for detecting the consumption of the edible mass, at least one concentrator module, and at least one remote server. The consumption detecting device has measurement electronics including a device for measuring a first frequency on a first relaxation oscillator including a first measurement capacitor formed by two plates located on either side of the edible mass, the edible mass forming a dielectric material between the plates. The boxes and the concentrator module are configured to transmit first measurements from the boxes to the concentrator. The first measurements are transmitted from the concentrator to the remote server. The remote server measures a frequency variation characteristic of the variation in density of the edible mass at least on the basis of a plurality of the first measurements.

### CROSS-REFERENCE TO RELATED APPLICATIONS

This application is based on and claims priority under 35 U.S.C. § 119 to European Patent Application No. 23189063.3, filed on Aug. 1, 2023, in the European Patent Office, the disclosure of which is incorporated by reference herein in its entirety.

### BACKGROUND

### Field

The disclosure relates to the field of protecting buildings and constructions against attacks by insect pests and more specifically relates to trap devices with baits suitable for underground insect pests and notably termites.

### Brief Description of Related Developments

Many examples exist of traps for underground insect pests such as termites and, for example, documents EP 2015159 A1, EP 3648594 A1 and US 2010/043276 A1 relate to devices that sink into the ground and can be filled either with a material that is palatable for termites to allow their presence to be detected when they eat this material or with a palatable material containing an insecticide intended to eradicate said termites.

Document US 2007/120690 A1 for its part describes a detection system comprising trap/bait boxes with an electronic detection circuit distributed over a land surface around a construction to be protected, and a device for polling said boxes.

### Technical Problem

A requirement exists to improve the detection of insect pest activity by means of traps/baits, to simplify the management of these traps/baits and to simplify the procedures for eradicating these insects and the present disclosure proposes a detection system allowing remote monitoring and planning of on-site interventions when the presence of insect pests is detected.

### SUMMARY

In view of this situation, the present disclosure more specifically proposes an insect pest detection system comprising:
a. a group of underground bait/trap boxes of the tubular box type provided with a housing provided with a first part, in the lower part of the box, for at least one edible mass comprising an edible material for said insects and provided with a device for detecting the consumption of said edible mass by said insects provided with measurement electronics comprising:
b. a device for measuring a first frequency on a first relaxation oscillator comprising a first measurement capacitor formed by two first plates located on either side of said edible mass, said edible mass forming a dielectric material between said plates;
c. a processor configured to take first measurements of the first frequency in accordance with a first schedule;
d. at least one concentrator module, the boxes of said group of boxes and said concentrator module each comprising first radio communication means configured to transmit said first measurements from said boxes to said concentrator in accordance with a second schedule;
e. at least one remote server;
   said concentrator module and said server each comprising second communication means configured to transmit said first measurements from the concentrator unit to the remote server in accordance with a third schedule, said remote server being provided with a monitoring program comprising computation means configured to measure frequency variations characteristic of a variation in density of the edible mass of at least one box of the group of boxes at least on the basis of a plurality of said first measurements, with said variation in density allowing the consumption of the edible mass by the insects to be detected.

The measurements that are periodically carried out allow continuous monitoring of the boxes connected to the concentrator, notably allowing the boxes that are the first to be infected to be determined and allowing the boxes that may need to be refilled with an edible mass comprising an insecticide composition to be determined.

According to aspects that can be combined or independent:

At least some of the boxes of said group of boxes can be provided with a compensation circuit comprising at least one second relaxation oscillator comprising a second measurement capacitor produced by second plates disposed above the first plates, said measurement electronics and said processor being configured to carry out second measurements of the second frequency in accordance with a fourth schedule and to transmit said second measurements to said concentrator in accordance with a fifth schedule.

Said fourth schedule can be the same as the first schedule and/or the fifth schedule can be the same as the second schedule.

Said boxes are each provided with a device for managing periodic sleep phases and wake-up phases of their processor, said processor is advantageously configured to carry out, during its wake-up phases, the frequency measurements by means of the device for measuring said frequencies and to manage the establishment and the continuation of communication with the concentrator module and to transmit said measurements to said concentrator module.

Said concentrator module for its part can be configured to communicate with said boxes in order to periodically receive said first measurements from each box, to compile said measurements from all the boxes of the group of boxes and to transmit said compiled measurements to said remote server provided with said monitoring program and computation means, said computation means can be configured to compute one or more variations in the frequency of the first oscillator for each box as a function of time so as to detect a characteristic variation in density of at least one of said edible masses on the basis of said variations.

The present disclosure further relates to a method for protecting a land surface, notably a land surface surrounding one or more buildings, by means of a detection system as described above, the method comprising:
a. installing a concentrator module;
b. installing a group of bait/trap boxes in said surface each containing an edible mass of edible material for said insects;
c. pairing said one or more boxes with said concentrator during a pairing step carried out for each of said boxes;
d. pairing said concentrator with the server during a pairing step carried out for said concentrator;
e. setting the concentrator to listen to said configured boxes and to periodically send said concentrator, after sleep periods, the frequency measurements carried out by the measurement devices of said boxes;
f. transmitting, in accordance with the third schedule, the measurements of the plurality of boxes from the concentrator to said remote server;
g. the remote server computing the variations in the series of frequency data as a function of time for each box of said group and assessing the variation in density of the contents of the trap for at least one of said edible masses on the basis of said variations by detecting inflection points and/or changes in slope in said series of data.

The remote server can process the measurement data in order to detect the presence of said insects in a box via the detection of measurement oscillations resembling either consumption of the matrix or an addition of soil, or both.

The method can comprise the remote server computing a change in said variation in density and an algorithm for determining, on the basis of said change, whether said insects are present in at least one box in order to trigger an intervention in order to place a bait in said at least one box comprising a lethal composition for said insect pest, or for determining, on the basis of said variation in density, the moment when said intervention is to be scheduled.

According to an advantageous aspect, said remote server can process the measurement data in order to determine a rate of consumption of the edible masses for each box and to generate said intervention schedule for the plurality of boxes.

The boxes can be configured to periodically transmit, in addition to the measurement data of the boxes, data frames comprising at least one data item from among:
a. a unique identifier of the box;
b. a temperature of the box;
c. a frequency measurement of the first relaxation oscillator;
d. a frequency measurement of the second relaxation oscillator;
e. a date of the measurement.

The boxes are provided with compensation circuits comprising at least one second relaxation oscillator comprising a second measurement capacitor produced by second plates disposed beyond the presence of said edible mass, said measurement electronics and said processors of said boxes can be configured to carry out second measurements of the second frequency in accordance with a fourth schedule and to transmit said second measurements to said concentrator in accordance with said fourth schedule, the remote server is configured to assess the consumption of the edible masses by the insects on the basis of computations comprising computations of differential frequencies between the frequency of the first relaxation oscillator and of the second relaxation oscillator.

The computations of differential frequencies between the first and the second relaxation oscillators can be of the following type:

$$F = ( {F}_{A} - {S}_{A} ) - [ ( {F}_{B} - {S}_{B} ) \times k ] ,$$

where:
   F is the resulting differential frequency, after compensation;
   F_{A}, F_{B} are the frequencies measured on the measurement capacitors A and B of the compensation circuit;
   S_{A}, S_{B} are compensation offsets of the capacitors A and B;
   k is a compensation constant that depends on the construction of the trap, the choice of materials and the size of the capacitor plates;
      with this computation being carried out for a series of successive measurements carried out by each box.

The offsets advantageously correspond to a no-load capacitance of the two capacitors A and B and are measured during a device initialization step when installing a trap without edible mass so that FA0=S_{A} and likewise FB0=S_{B}.

The remote server can be configured to record the measurements originating from the boxes and to form a measurement database forming a deep learning database for a neural network.

In a complementary or alternative manner, the remote server can be configured to estimate the consumption of the edible masses using an artificial intelligence algorithm based on said neural network previously trained with said deep learning database for the frequency measurements.

The concentrator can send the server, in addition to the measurement data, data frames comprising at least one of the data items from among:
a. a reception level of the concentrator in dBm;
b. a version of the concentrator module software;
c. a version of the software for communicating from the concentrator module to the remote server;
d. an indication that the concentrator module is being paired;
e. a table including at least one of the following for each box:
f. a unique identifier of the box;
g. a reception level of the radio signal between the box and the concentrator;
h. a remaining battery level of the box as a %;
i. a software version of the box;
j. one or more data items indicating whether the box is in pairing mode.
   Preferably, the remote server is configured to carry out a diagnostic, on the basis of the received data, of the operation of the communication means of the concentrator module, as well as to carry out a diagnostic of the battery of the box and the communication device of the box.

The server comprising a gathering device configured to gather the messages originating from boxes as transmitted by the concentrator modules, the method may comprise implementing a processing process comprising generating a map, and/or a list and/or a table representing the distribution of boxes connected to a concentrator module for which the presence of insects has been detected and a web service and/or mobile application process adapted to allow said map, said list or said table to be consulted by users.

The server comprising a database of interventions representing the locations of boxes and of concentrator modules in a region, the method may comprise implementing a process for organizing a schedule of interventions on said boxes in said region by technicians monitoring said boxes and concentrator modules as a function of the progress of the consumption of said edible masses.

The method may comprise updating by technicians the database of interventions with the interventions that have been carried out.

Once the insects have been detected, the edible masses can be replaced or supplemented by pellets or other edible masses containing an insecticide composition. The insects concerned by the present disclosure are termites in particular.

### BRIEF DESCRIPTION OF THE DRAWINGS

Further features, details and advantages of the disclosure will become apparent from reading the following detailed description of non-limiting aspects, and with reference to the appended drawings, in which:

FIG. 1 shows an exploded view of a box according to the present disclosure;

FIG. 2 shows a schematic view of the electronics of a box according to the present disclosure;

FIG. 3 shows details of frequency generator circuits;

FIG. 4 shows a view of the box of FIG. 1 and of consumables adapted to this box;

FIG. 5 schematically shows the operating steps of a box;

FIG. 6 shows a simplified diagram of a concentrator;

FIG. 7 shows a schematic view of an insect pest detection system;

FIG. 8A, FIG. 8B, FIG. 8C show curves for detecting insect pest activity by the insect detection system of the present disclosure;

FIG. 9 shows a simplified flow chart of a step of a method according to the present disclosure;

FIG. 10A, FIG. 10B, FIG. 10C show detection curves of the insect detection system of the present disclosure in a non-infested box.

### DETAILED DESCRIPTION

The drawings and the following description contain elements that not only can be used to better understand the present disclosure, but also can assist in its definition, where appropriate.

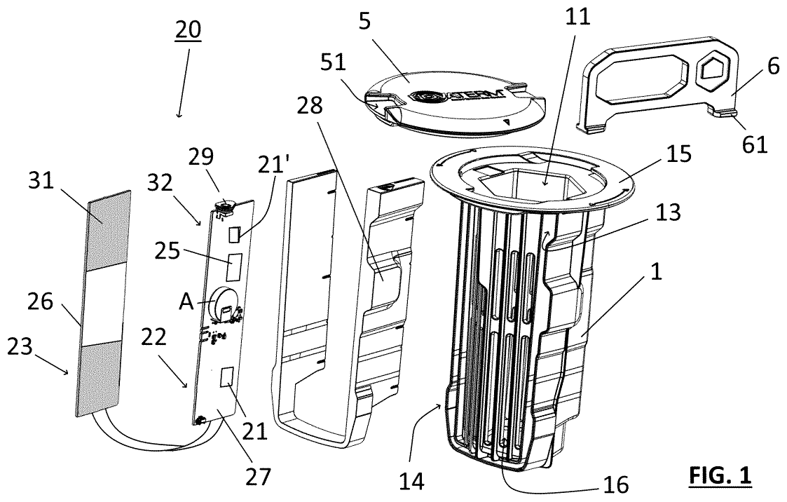

The insect pest detection device notably shown in FIG. 1 comprises a perforated tubular box 1 that can be installed in the ground.

This box has a longitudinal axis A that will be a vertical axis once the box is installed in the ground, and an upper flange 15 that will rest on the ground once the box is embedded in the ground. It comprises a perforated tubular enclosure 12, provided with vertical slots 16 to this end, which enclosure forms a housing that extends along the longitudinal axis A from an open top of the box comprising said flange to the bottom of the box, with the housing roughly being divided in half between an upper part and a lower part.

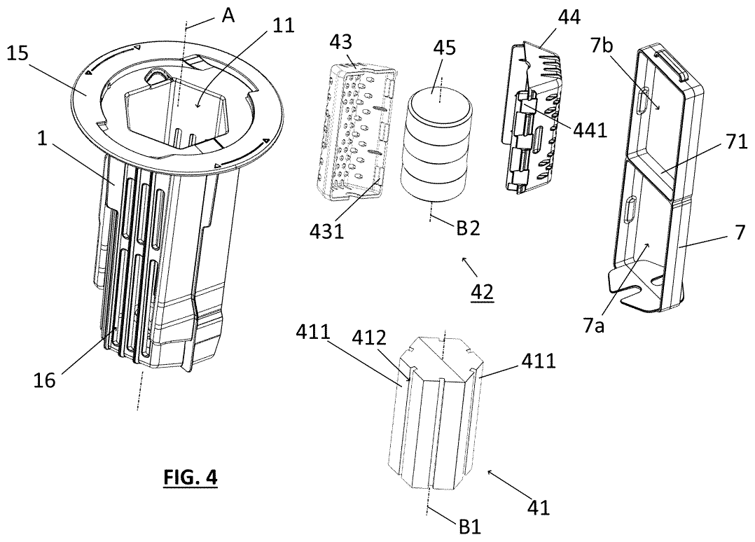

According to one aspect, the housing is intended to initially receive an edible mass 40 of edible material for said insects, as shown, for example, in FIG. 4, in the form of a block of wood or of cellulose-based material that is housed in the bottom of the housing.

The housing 11 can then receive said block and a refill 42, also shown in FIG. 4, which will be described hereafter.

The edible mass 40 can be a block 41 as described above, but the edible mass also can be a stack of pellets. The block of wood can be solid wood or a mixture of cellulose. The solid wood can be poplar, for example, which is less sensitive to humidity than cellulose. The edible mass in the form of a block can be a cylinder with a circular or hexagonal cross-section in one or two parts.

With further reference to FIG. 1, the tubular enclosure 12 comprises, on two of its opposite sides, double walls forming lateral cavities 13, 14. These lateral cavities, one transverse end of which perpendicular to the longitudinal axis of the box between the double walls is open, while the other transverse end is closed, will receive electronics 20 for detecting the activity of said insects, an aspect of which is described hereafter.

The tubular enclosure 12 of the box according to the example has a hexagonal cross-section in a plane transverse to said axis A and said double walls are disposed facing each other along two diametrically opposite faces of said enclosure. The enclosure also can have a generally oval cross-section with two flattened faces where the lateral cavities 13, 14 are formed.

Still with reference to FIG. 1, the electronics 20 for detecting the activity of said insects comprises at least two capacitive detection electrode plates 22, 23, with these electrode plates being disposed in the lateral cavities 13, 14 on either side of the lower part of the tubular housing 11 receiving the block 41 of edible material for said insects.

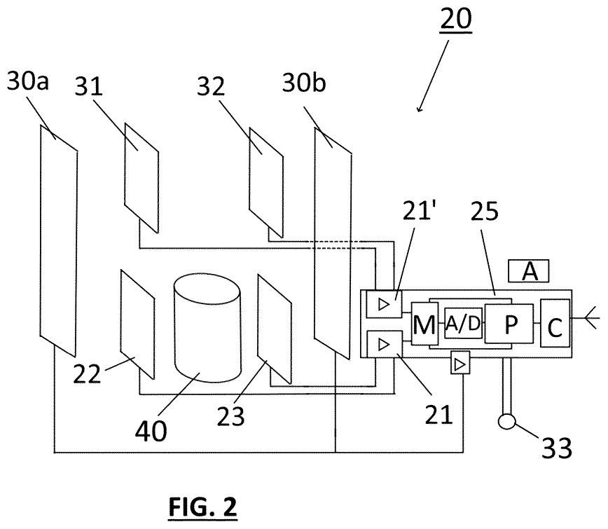

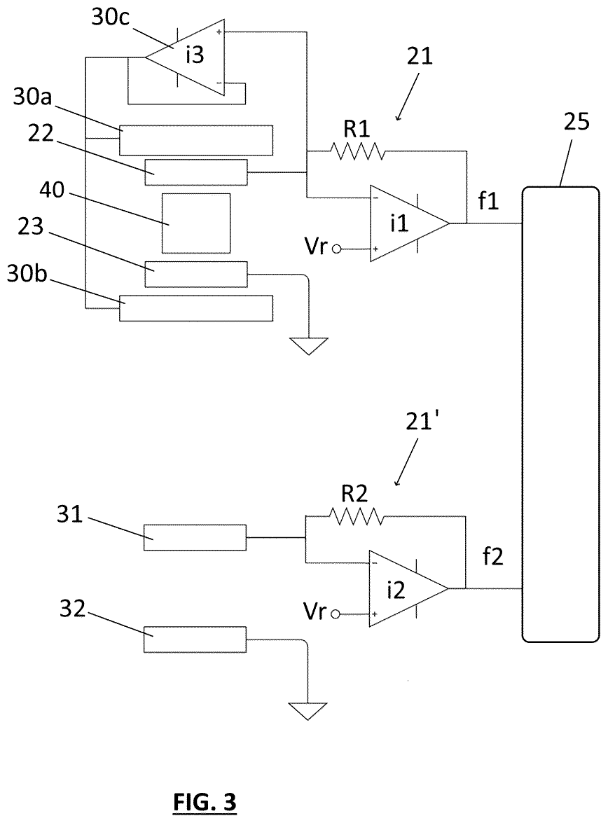

The detection electronics schematically shown in FIG. 2 comprise a first frequency generator circuit with a relaxation oscillator 21, as shown in FIG. 3, for example, and said capacitive detection electrode plates 22, 23 as a capacitive element. The first frequency generator circuit is connected to an oscillation frequency detection device 25, with said relaxation oscillator 21 being configured to generate a first oscillation frequency f1 that is at least partly dependent on the density of said edible mass 40 so that the consumption of this edible mass 40 by said insects modifies the first oscillation frequency f1 of said oscillator.

Still according to FIG. 3, the first frequency generator comprises an operational amplifier i1, the output of which is connected to the negative input by a resistor R1, with this negative input receiving a capacitive detection electrode plate 22, while the other capacitive detection electrode plate 23 is connected to a fixed potential, such as the edible mass of the detection electronics. The resistor R1 and the operational amplifier i1 are selected such that, when the box is calibrated off the ground and without a block 41 in the housing 11 with detection plates of the order of 30 mm to 60 mm high and 20 mm to 50 mm wide, and preferably of the order of 50 mm×35 mm and spaced apart by 50 to 70 mm and preferably 60 mm, the generator generates an initial frequency f1=S_{A} of the order of 10 kHz to 400 kHz and preferably of the order of 100 kHz, plus or minus 20 kHz.

The electronics further comprise a temperature sensor 33.

According to this example, the device comprises a second frequency generator circuit with a relaxation oscillator 21′ provided with at least two capacitive compensation electrode plates 31, 32 as capacitive elements, disposed in the box on either side of an upper part of the tubular housing.

Still according to the example in FIG. 3, a first compensation plate 31 is connected to the negative input of a second operational amplifier i2, while the second compensation plate 32 is connected to a zero potential of the detection electronics.

Similarly, the resistor R2 and the operational amplifier i2 of said second circuit are such that when the box is calibrated off the ground with plates with a similar height, width and spacing to the detection plates, the compensation frequency f2=S_{B} is of the same order, from 10 kHz to 400 kHz, and preferably of the order of 50 kHz, plus or minus 20 KHz.

While the frequency f1 emitted by the first frequency generator circuit will change as a function of the variation in density of the edible mass 40 disposed between the capacitive detection electrode plates 22, 23 when it is consumed by the insects, the frequency f2 emitted by the second frequency generator circuit will, in the absence of edible mass between the compensation electrode plates, evolve differently from the frequency generated by the first frequency generator and, for example, will depend on the humidity and temperature conditions in the ground in the vicinity of the compensation electrode plates 31, 32 or will react to any addition of soil by the insects, which optionally allows the measurements to be refined, as will be seen hereafter.

The processor P notably can be made up of a low consumption microcontroller associated with a random-access memory and a non-volatile memory that may be programmable or reprogrammable, such as, for example, a Flash memory, an EPROM or an EEPROM that contains the program for carrying out the measurements, said memories can be fully or partly included in said microcontroller.

The microcontroller can also include the operational amplifiers 21, 21′ each connected to an analogue/digital converter circuit M or connected to a single converter via a multiplexer, with said one or more converters converting the frequencies generated by said first frequency generator circuit and second frequency generator circuit into digital frequency signal data and being connected to a computation unit configured to measure said digital frequency signal data.

According to an aspect that is not described, the operational amplifiers i1 and i2 also can be replaced by a single operational amplifier preceded by a multiplexer that will alternately connect the plates 22 and 31 to said single operational amplifier in order to alternately carry out the frequency measurements at the output of said operational amplifier.

The device further comprises an active shield provided with two plates 30a, 30b brought to the potential of a capacitive electrode plate of the first relaxation oscillator 21 so as to make the measurements independent of any ambient electromagnetic noise. This active shield includes a third operational amplifier i3 wired as a follower, to which the two plates 30a, 30b are connected.

According to FIG. 2, said electronics comprise a communication module C that may or may not be integrated in said processor and is provided with a radio transmission/reception device configured to transmit said digital data to a remote monitoring system 8. The electronics further comprise a power supply device A provided with a battery and a device for placing the electronics on deep standby and for waking them up in order to reduce consumption so as to aim for device autonomy of at least 2 to 5 years.

With further reference to FIG. 1, the detection electronics still comprise, according to the example, two printed circuit boards 26, 27, with a first one of the boards 26 comprising a first 22 one of said capacitive detection electrode plates, said frequency generator circuits 21, 21′ and said oscillation frequency detection device 25, and a second one of the boards 27 connected to the first by a flexible circuit or connecting wires comprising a second 23 one of said capacitive detection electrode plates.

In the example shown, the first one of said boards 26, 27 supports a first capacitive compensation electrode plate and the second one of said boards supports a second capacitive compensation electrode plate.

The active shielding plates 30a, 30b can be made from particular layers of multilayer printed circuit boards like ground planes.

As shown in FIG. 1, the electronics positioned in said cavities are embedded in a protective coating 28, which allows through a luminous indicator 29 that is controlled by the processor P in order to display the pairing sequence that is initiated, for example, by pressing and holding a button on the box connected to the processor in order to trigger a pairing sequence.

Mechanically, the box 1 receives the edible mass 40, such as a block 41, in the bottom of the housing 11, with the block 41 being positioned in a drawer frame 7 that is detachably inserted into the tubular housing. The drawer frame comprises two housings 7a and 7b separated by a crosspiece 71 so that the drawer frame can receive refills 42 comprising an insecticide composition in pellets 45 edible by insects in a portion of the box for receiving a refill 42 above the bottom part of the box receiving said block.

The edible block 41 for said insects comprises, according to the example, a cylindrical assembly with an even hexagonal cross-section perpendicular to an axis B1 passing through the center of said cross-section, formed from two solid wood parts 411 with a trapezoidal prismatic cross-section and comprises external grooves 412 parallel to said axis of rotation. The two-part configuration allows manufacturing of the block to be simplified and reduces its cost by using thinner wooden parts than for the whole block.

The external grooves 412 create areas where insects can attack the block.

The refills, also called capsules, received in the part of the tubular housing above the bottom part of the box receiving said block, comprise a perforated package 43, 44 and pellets 45 that can be consumed by said insects.

The drawer frame receives the refill 42 in its upper housing 7b above the block 41, with the refill 42 and the block 41 being separated by the crosspiece 71.

The top of the box has a detachable cover 5 for closing the tubular housing. The cover can be removed in order to insert the drawer filled with one or two edible masses or one or two refills or a refill/edible mass combination, and then removed again.

According to the example, the quarter-turn type cover with tabs fitting into grooves in the box is provided with notches 51 for snap-fitting on feet 61 of a detachable handle 6.

The refill comprises a package 43, 44 and pellets 45 that can be consumed by said insects, the package is a perforated package that comprises two perforated half-shells provided with matching snap-fitting means 431, 441 or connected by a hinge so that the operator does not directly handle the insecticide pellets, which in this case are cylindrical pellets of edible material stacked in said package.

Notably, the pellets are made up of compressed cellulose chips or granules that may or may not contain an insecticide composition.

In order to conform to the housing of the box, the package 43, 44 has a hexagonal cross-section perpendicular to a central longitudinal axis B2 of said refill.

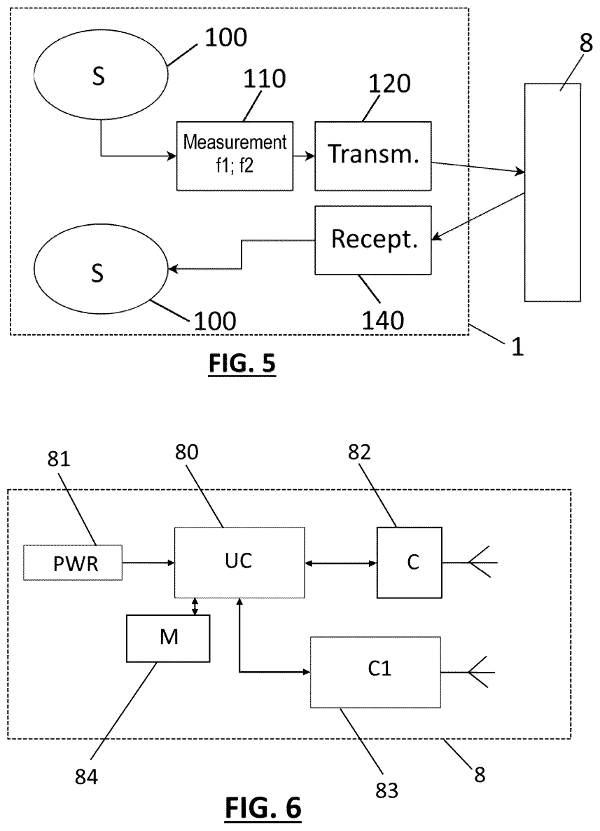

The operation of the box is illustrated in FIG. 5. The processor of the detection electronics has a standby phase 100 and exits this phase in order to carry out a measurement 110 of the frequencies f1 and f2 on the oscillators. Once the measurements have been carried out, the box sends these measurements to the concentrator 8 in step 120, then receives an acknowledgement of receipt and an order to return to standby mode 140. The box returns to standby for a duration that is predetermined in the box processor.

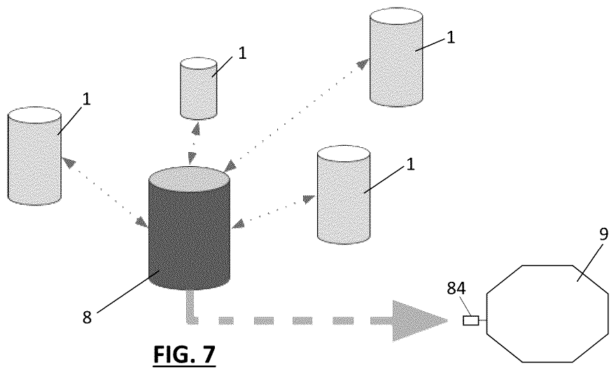

The concentrator 8 is schematically shown in FIG. 6 and comprises a processor 80, an electrical power supply 81, a memory 84 comprising a programmable memory part receiving the concentrator operating software and a random-access memory part notably used to store the measurements and the data originating from the boxes before transmitting them to the server 9 shown in FIG. 7. In order to communicate with the boxes, the concentrator comprises a first radio communication module 82, for example, using a Wi-Fi type sub-GHz protocol, and, in order to communicate with the server 9, the concentrator comprises a second communication module 83 adapted to communicate with the server provided with communication means 84 using a 2G, LTE-M, NB-IOT, 4G or 5G protocol, for example.

The detection of insect activity is mainly based on the consumption of the edible mass disposed between the detection electrodes. This detection is based on the series of measurements acquired per box and, notably, by seeking significant variations in the frequency of the first oscillators of the boxes that are likely to form an image of the reduction in density of the edible masses.

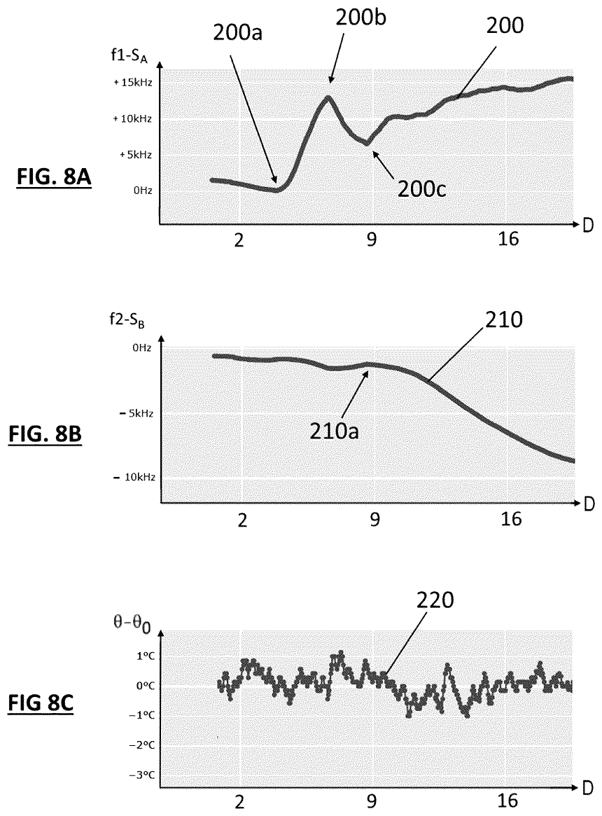

An example of frequency curves as a function of time during a test over approximately twenty days D on a termite mound farm, with edible masses of the wooden block type, is provided in FIGS. 8A to 8C.

FIG. 8A shows a curve 200 corresponding to a variation in frequency f1-S_{A} with respect to time in days D, where S_{A} is the frequency of the first relaxation oscillator in the initial state and f1 is the frequency of the first oscillator at a given instant.

FIG. 8B shows a curve 210 corresponding to a variation in frequency f2-S_{B} with respect to time in days D, where S_{B} is the frequency of the second relaxation oscillator in the initial state and f2 is the frequency of the second oscillator at a given instant.

FIG. 8C shows a curve 220 corresponding to a temperature variation in ° C. in the vicinity of the box electronics during the measurement.

In this example, it can be seen that on the curve 200 of FIG. 8A a first inflection 200a starting a positive slope of the increase in frequency of the oscillator marks the beginning of consumption of the edible mass by the insects, a second inflection 200b starting a negative slope corresponds to the addition of earth in the vicinity of the edible mass, ending at a third inflection 200c starting a second positive slope corresponding to continuous consumption of the edible mass by the insects. The detection program is designed to detect these variations and to deduce therefrom the presence of insects consuming the edible mass.

At the same time, FIG. 8B shows, on the frequency variation curve 210 of the second relaxation oscillator, a reduction in frequency from an inflection point 210a, with this reduction in frequency corresponding to filling of the space between the plates 31, 32 of the electrodes of the capacitor of the compensation circuit.

FIG. 8C shows that the temperature remains stable at plus or minus 1° C. for the duration of the measurements and, in this case, has no effect on detection.

Thus, the possible reverse variations in the evolution of the frequency of the second oscillator over time can indicate colonization of the box and the addition of soil by the insects. Such an addition of soil can be a construction or an aggregation of tunnels formed by the insects, notably in the case of termites.

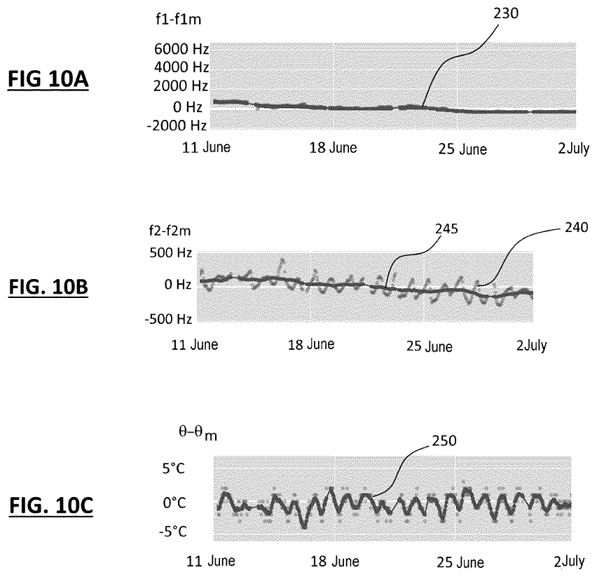

On the other hand, FIGS. 10A and 10C correspond to curves for an uninfested box, comprising an edible mass in the form of a block of wood in the vicinity of the electrodes of the first oscillator and devoid of an edible mass in the vicinity of the electrodes of the second oscillator. This box is disposed in a region where only the temperature varies, and it can be seen that the curves remain relatively stable for both the first oscillator and the second oscillator.

Curve 230 of FIG. 10A corresponds to the frequency f1-f1m, the frequency f1 of the first oscillator whose capacitor plates are disposed on either side of the edible mass, averaged over a 48-hour window, from which the median value f1m is subtracted with temperature compensation, curve 240 of FIG. 10B corresponds to the frequency f2 averaged over a 48-hour window, from which the median value f2m is subtracted before temperature compensation, curve 245 corresponds to the frequency f2-f2m after temperature compensation, curve 250 of FIG. 10C corresponds to the temperature θ recorded during the measurements averaged over a 6-hour period, from which the median temperature θₘ is subtracted.

For a group of boxes 1 connected to a concentrator 8, on the basis of frequency data measured in accordance with a first schedule, for example, several times a day, on the first oscillator of each box and optionally on the second oscillator, it is possible to consolidate these data on the concentrator and then to transmit them, in accordance with a second schedule, for example, every day, to the remote server 9.

In terms of the remote server, computations are carried out in order to detect inflections and frequency variation slopes in the series of data gathered from each box.

This corresponds, for example, to curve 200 for an infested box, but in addition comparisons of values and variations in the data are also made between the boxes so as to compute a probability of the presence of insects in one or more of these boxes.

Indeed, when an area is equipped, for example, with approximately ten boxes distributed in a circle around a construction, generally only some of the boxes are infested when the insects to be eradicated are present. As a result, since infestations occur in a given direction, if boxes surround a building to be protected, comparing the data between the boxes allows frequency variations to be detected on certain boxes, while the majority of boxes exhibit data that is stable or varies in a similar way as a function of the humidity and temperature conditions in the ground. This allows the presence of insects to be detected, for example, by setting a variation threshold such as a 20% or 30% frequency deviation on one box compared with the average of the values of the other boxes over a given period of time, for example, a day or a week.

Computations of the presence of insects can take into account other parameters such as the temperature and/or the humidity of the boxes in order to optionally compensate for any frequency variations due to these parameters and to refine the detection of the presence of insects.

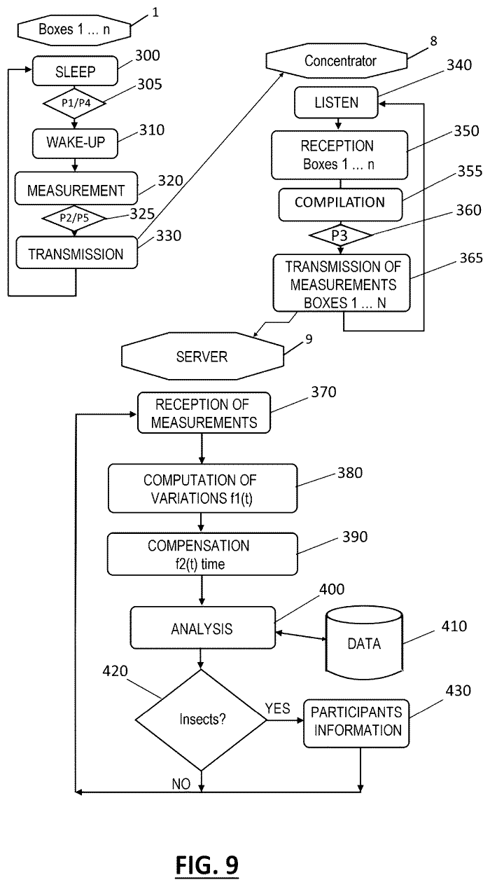

FIG. 9 shows a simplified flow chart of the operation of a system produced according to the present method.

The boxes 1 have sleep cycles 300 and wake-up cycles 310 timed in accordance with the first schedule P1 for the measurements 320 of the frequency of the first oscillator 21 or timed in accordance with the fourth schedule P4 for the measurements of the frequency of the second oscillator 21′. It should be noted that the first schedule can be equal to the fourth schedule, with the measurements being carried out during the same wake-up phase. Then, in accordance with the second schedule or the fifth schedule 325, the measurements are transmitted 330 to the concentrator 8.

Similarly, the second schedule and the fifth schedule can be identical and, for the sake of simplicity, a common schedule can be selected for the measurement and transmission operations such that P1=P2=P4=P5. The measurement and transmission schedules can be fixed or variable on command from the concentrator in accordance with instructions from the server, for example, to increase the measurement schedule when a significant frequency variation is detected.

In step 350, the concentrator 8 receives all the data from the boxes and stores them in order to compile the measurement data from the boxes in step 355 and then, in accordance with a third schedule P3 360, transmits 365 them to the server 9. The transmission 365 can occur as soon as all the boxes of the group of boxes have transmitted their measurements or after receiving several sets of compiled measurements, for example, in the event that the boxes transmit measurements every hour or several times a day, the concentrator can be equipped with a large enough memory to transmit the data stored over several days of measurements so as to limit the number of transmissions and therefore the transmission cost in the event that these are made over a mobile telephone network. Data transmission is thus determined by a memory capacity and a schedule.

At the server level, after the measurements 370 have been received, a computation program 380 computes the frequency variations over the frequency series measured on the first oscillator 21, the program can also include computation modules for:

according to step 390:
computing compensation data originating from the second oscillator;

or
computing, in the same way as for the first oscillator, frequency variations of the second oscillator 21′ in order to detect, with this oscillator, when an edible mass is also present in the upper part;

or compensate the oscillator measurements according to the measured temperature.

An analysis program 400, for example, based on a neural network trained with series of data made up of measurements from several installed sites and entered in databases 410, can detect 420 whether or not insects are present. In the event that insects are detected in at least one box, the participants monitoring the system are informed, in step 430, that an intervention needs to be carried out.

To this end, the participants use, for example, an application involving the generation of a map and/or a list and/or a table representing the distribution of the boxes connected to a concentrator module for which the presence of insects has been detected and a web service process and/or mobile application adapted to allow users to consult said map, said list or said table.

The insect pest detection system therefore comprises:
a. a group of underground bait/trap boxes 1 of the tubular box type provided with a housing 11 receiving, in the lower part thereof, at least one edible mass 40 of edible material for said insects and provided with a device for detecting the consumption of said edible mass by said insects provided with measurement electronics 20 and provided with:
   i. a device 21, 22, 23 for measuring a first frequency on a first relaxation oscillator 21 comprising a first measurement capacitor formed by two first plates 22, 23 located on either side of said edible mass that forms a dielectric material between said plates;
   ii. a processor 25 configured to take first measurements 320 of the first frequency f1 in accordance with a first schedule P1.

The group of boxes is connected to a concentrator module 8, the boxes 1 of said group of boxes and said concentrator module each comprising first radio communication means C, 82 configured to transmit 330 said first measurements from said boxes to said concentrator in accordance with a second schedule P2.

The concentrator module 8 is connected to at least one remote server 9, said concentrator module and said server each comprising second communication means 83, 84, for example, cellular telephony communication modules of the 4G or 5G type, configured to transmit said first measurements from the concentrator unit 8 to the remote server 9 in accordance with a third schedule P3.

The remote server is provided with a monitoring program comprising computation means 380, 390 configured to measure a frequency variation characteristic of the variation in density of the edible mass of at least one box of the group of boxes at least on the basis of a plurality of said first measurements.

The measurement principle described above can, under certain conditions, allow the presence of insect pests to be detected directly, but, according to the example shown, the boxes are provided with the second relaxation oscillator 21′ comprising a second measurement capacitor produced by second plates 31, 32.

According to FIG. 2, said measurement electronics 20 and said processor 25 are then configured to carry out second measurements of the second frequency in accordance with a fourth schedule P4 and to transmit said second measurements to said concentrator in accordance with a fifth schedule P5.

According to FIG. 5, the boxes 1 are each provided with a device 100 for managing periodic sleep phases and wake-up phases of their processor, said processor is advantageously configured to carry out, during its wake-up phases, the frequency measurements 110 by means of the device for measuring said frequencies and to manage the establishment and the continuation of communication with the concentrator module and to transmit 120 said measurements to said concentrator module 8.

The concentrator module is configured, for its part, to communicate with said boxes in order to periodically receive said first measurements from each box, to send them data such as the schedules P1, P2, P4, P5, program updates or other data, but also to send said measurements to said remote server 9 provided with the monitoring program.

The computation means of the server are configured to compute, for each box, variations in the frequency of the first oscillator as a function of time and to carry out statistical comparisons on the gathered frequency data so as to detect a reduction in the density of at least one of said edible masses on the basis of said variations. Another possibility or an additional detection can involve a large addition of possibly damp soil in the vicinity of the compensation electrodes, which also can be an indication of infestation by the insects to be eradicated.

The concentrator module 8 also can be configured to communicate with said boxes 1 in order to periodically receive said first measurements from each box, to compile said measurements from all the boxes of the group of boxes and to transmit 365 said compiled measurements to said remote server provided with said monitoring program, said computation means being configured to compute, for each box, the variations in the frequency data as a function of time and to carry out a statistical comparison of said variations so as to detect a reduction in the density of at least one of said edible masses on the basis of said variations, an abnormal increase in density in the vicinity of the compensation electrodes if they are used, or a combination of both phenomena.

The present disclosure further provides a method for protecting a land surface, notably a land surface surrounding one or more buildings, by means of a detection system according to the present disclosure that can comprise the following operations:
a. installing a concentrator module;
b. installing a group of bait/trap boxes each containing a mass of edible material, called edible mass, for said insects in said surface;
c. pairing said one or more boxes with said concentrator during a pairing step carried out for each of said boxes;
d. setting the concentrator to listen to said configured boxes in order to periodically send said concentrator module, after sleep periods, the frequency measurements carried out by the measurement device;
e. transmitting, in accordance with a second schedule, the measurements of the plurality of boxes to the concentrator, then transmitting, in accordance with a third schedule, the measurements from said concentrator to said remote server;
f. the remote server computing variations in the frequencies as a function of time for each box of said group on the basis of a plurality of measurements and assessing the variation in density of the contents of the trap for at least one of said edible masses on the basis of said variations by detecting inflection points or changes in slope on the basis of the frequency data as a function of time.

Said one or more boxes is/are paired with said concentrator using an application on a mobile telephone or a tablet.

According to a first aspect, a detection program on the remote server is designed to monitor a change in the variation in the density of edible masses and an algorithm determines, on the basis of this change, whether said insects are present in at least one box in order to trigger an intervention in order to place a bait in said at least one box that comprises a lethal composition for said insect pests or to determine, on the basis of this change, the moment from which said intervention should be scheduled.

The remote server can process the measurement data in order to determine a rate of consumption of the edible masses for each box and to generate said intervention schedule for the plurality of boxes.

The data periodically transmitted from the boxes to the concentrator, together with the measurement data, can comprise at least one data item from among:
a. the unique identifier of the box;
b. the temperature of the box;
c. a frequency measurement of the first relaxation oscillator;
d. a frequency measurement of the second relaxation oscillator;
e. a date of the measurement.

The computations of the presence of insects can take into account other parameters such as the temperature and/or humidity of the boxes.

If necessary, a differential frequency can be computed between the frequency of the first oscillator and the frequency of the second oscillator and the computations of differential frequencies between the first and the second relaxation oscillators can be of the following type:

$$F = ( {F}_{A} - {S}_{A} ) - [ ( {F}_{B} - {S}_{B} ) \times k ] ,$$

where:
   F is the resulting differential frequency, after compensation;
   F_{A}, F_{B} are the frequencies measured on the measurement capacitors A and B of the compensation circuit;
   S_{A}, S_{B} are compensation offsets of the capacitors A and B;
   k is a compensation constant that depends on the construction of the trap, the choice of materials and the size of the capacitor plates.

This computation notably can be carried out for a series of successive measurements carried out by each box in the event that the second oscillator is used to make compensation measurements when no edible mass is disposed between the electrodes of the second oscillator.

The offsets can correspond to a no-load capacitance of the two capacitors A and B and are measured during a device initialization step when installing a trap without edible mass so that FA0=S_{A} and likewise FB0=S_{B}.

The remote server can be configured to record the measurements originating from the boxes and to form a measurement database on the basis of these data forming a deep learning database for a neural network.

The remote server can be configured to detect or even estimate the consumption of the edible masses using an artificial intelligence algorithm based on said neural network previously trained with said deep learning database for the frequency measurements.

In order to manage the operation of the system, the data frames can further comprise at least one of the data items from among:
a. a reception level of the concentrator in dBm;
b. a version of the concentrator module software;
c. a version of the software for communicating from the concentrator module to the remote server;
d. an indication that the concentrator module is being paired;
e. a table including, for each box:
f. a unique identifier of the box;
g. a reception level for the box in dBm;
h. a remaining battery level of the box as a %;
i. a software version of the box;
j. a data item indicating whether the box is in pairing mode.

On the basis of these data, the remote server, if it is configured as such, can notably carry out a diagnostic of the operation of the communication means of the concentrator module, and can carry out a diagnostic of the battery of the box and the communication device of the box and a general diagnostic of the system.

A processing process comprising generating a map of the area receiving the boxes or a table representing the state of consumption of the edible masses in the boxes connected to a concentrator module can be implemented to determine whether some of the boxes are more infested than others. The method can also include a web service process adapted to allow said map or said table to be consulted by users.

The server comprising a database of interventions representing the locations of boxes and of concentrator modules in a region, the method can comprise implementing a process for organizing a schedule of interventions on said boxes in said region by technicians monitoring said boxes and concentrator modules as a function of the progress of the consumption of the edible masses in the boxes. Once the interventions have been carried out, the operators can update the intervention database in order to monitor the regions where groups of boxes are installed.

In terms of the use of the device, several aspects are possible.

In one aspect, comprising a configuration in which the second generator is used to compensate for the measurements originating from the first frequency generator, an edible mass is disposed in the lower part of the basket and the upper part of the basket remains devoid of any block or edible mass. In this case, the second oscillator can be used to generate a second oscillation frequency f2 dependent on variations in the humidity level in the box or to allow detection of the addition of soil in the box by the insects.

In another aspect, for example, which is useful when only slight variations in temperature and humidity are to be expected in the region equipped with the devices, a second edible mass is disposed in the upper part of the housing in order to increase, for example, the detection capacity of the device. The two generators then help to detect a reduction in the density of the edible masses, allowing the presence of insects to be detected. This configuration increases the amount of edible material available and the possible detection height.

In a particular aspect, the user has the option of placing lethal edible matrices or lethal edible capsules at the top and at the bottom of the box when the devices are installed. The two pairs of electrodes will then measure what happens in the upper part and in the lower part of the housing. In this configuration, poisoning of the colony begins as soon as the insects infest the one or more housings. Detection occurs in the upper part and in the lower part of the boxes and, when the insects are detected, the operators know which box, or which boxes, of an installation are infested and can therefore determine when they need to intervene in order to replace the consumed matrices or capsules.

Thus, the box and the associated detection system can be used flexibly and can be adapted to the context, whether this is the temperature or humidity conditions or greater or lesser activity of the insect colonies to be eradicated.

In summary, from a mechanical and electronic perspective, the device for detecting insect pests comprises a perforated tubular box 1 that can be installed in the ground, provided with a longitudinal axis A and provided with electronics 20 for detecting the activity of said insects.

a. The electronics in this case comprise at least two first capacitive detection electrodes 22, 23 disposed on either side of a lower part of a tubular housing 11 extending along the longitudinal axis A from an open top to a bottom of the box, with said lower part receiving at least one edible mass or block 41 of edible material for said insects in a portion of the housing located in the bottom of said box.

This block can be formed by a solid block, optionally in two parts, or of pellets contained in a capsule.

The electronics comprise further a first frequency generator circuit with a relaxation oscillator 21 and comprising said capacitive detection electrode plates 22, 23 as a capacitive element, connected to an oscillation frequency detection device 25, said relaxation oscillator 21 being configured to generate a first oscillation frequency f1 at least partly dependent on the density of said block 41 so that the consumption of said edible mass 40 by said insects modifies the first oscillation frequency f1 of said oscillator.

The oscillation frequency detection device 25 comprises a processor P, such as a microcontroller provided with analogue/digital conversion means, configured and programmed to carry out measurements of said frequencies on said first frequency generator.

In a particular version, the detection electronics comprise a second frequency generator circuit with a second relaxation oscillator 21′ and comprising at least two second capacitive compensation electrode plates 31, 32 as a capacitive element, disposed in the box on either side of an upper part of the tubular housing, said second circuit being connected to said oscillation frequency detection device 25 and being configured to generate a second oscillation frequency f2 dependent on the environment of said trap and on a possible addition of earth into the trap by said insects or representing the consumption of a second edible mass by the insects or of a refill disposed in the upper part of the housing.

As seen above, the device is flexible in that detection can also involve using the second frequency generator as a detector by adding an edible mass, block or capsule provided with cellulose pellets with or without insecticide, as required, to the upper part of the housing.

The electronic circuit can be constructed as two printed circuit boards 26, 27, with a first one of the boards 26 comprising a first 22 one of said first capacitive detection electrode plates, said one or more frequency generator circuits 21, 21′ and said oscillation frequency detection device 25 and a second one of the boards 27 comprising a second 23 one of said first capacitive detection electrode plates.

The first one of said boards 26, 27 supports a first 31 one of said second capacitive compensation electrode plates and the second one of said boards supports a second 32 one of said second capacitive compensation electrode plates when said electrodes are present.

The first relaxation oscillator 21 and the second relaxation oscillator 21′ are made from at least one operational amplifier i1, i2.

Said processor P is, according to the example, a microcontroller comprising said operational amplifiers i1, i2 and an analogue/digital converter circuit M converting the frequencies generated by said first frequency generator circuit and second frequency generator circuit into digital frequency signal data and being connected to a computation unit configured to measure said digital frequency signal data, said electronics comprising a communication module C that may or may not be integrated in said processor and provided with a radio transmission/reception device configured to transmit said digital data to a remote monitoring system 8.

An active shield provided with two plates 30a, 30b brought to the potential of a capacitive electrode of the first relaxation oscillator 21 is advantageously integrated into the trap.

The perforated tubular box comprises a perforated tubular enclosure 12 forming a peripheral wall of said tubular housing 11, produced around the longitudinal axis A of said box and receiving said block or said edible mass, and double walls forming lateral cavities 13, 14, for receiving said electronics 20 for detecting the activity of said insects, diametrically opposite said enclosure relative to said longitudinal axis A and covering the sides of said enclosure 12.

The tubular enclosure 12 has a hexagonal cross-section in a plane transverse to said axis A and for which said double walls are disposed facing each other along two diametrically opposite faces of said enclosure.

Preferably, said electronics positioned in said cavities are embedded in a protective coating 28 protecting them from insects and humidity.

The device can also comprise a drawer frame 7 initially intended to receive a block 41 in the lower part and a refill in the upper part in the most common cases of use, with the drawer frame being detachably inserted into the tubular housing. Other configurations for filling the drawer frame can be contemplated, for example, the drawer frame is fitted with two refills 42 provided with an insecticide composition, notably when the infestation is characterized, or the drawer frame is fitted.

The edible block 41 for said insects can comprise a cylindrical assembly with an even hexagonal cross-section perpendicular to an axis B1 passing through the center of said cross-section, formed by two solid wooden parts 411 with a trapezoidal prismatic cross-section and comprises external grooves 412 parallel to said axis of rotation.

The tubular housing comprises, above the bottom part of the box receiving said block, a part for receiving a refill 42 comprising a perforated package 43, 44 and pellets 45 that can be consumed by said insects.

Said drawer frame 7 can comprise a housing for receiving said block 41 and a housing for receiving said refill 42 separated by a crosspiece 71.

The top of the box can comprise a cover 5 provided with notches 51 for snap-fitting feet 61 of a detachable handle 6 for closing the tubular housing.

The refill can comprise a perforated package 43, 44 receiving pellets that can be consumed by said insects. The package can comprise two perforated half-shells provided with matching snap-fitting means 431, 441 or connected by a hinge.

Said pellets 45 can be cylindrical pellets of edible material stacked in said package.

Said package 43, 44, according to the example, has a hexagonal cross-section perpendicular to a central longitudinal axis B2 of said refill. The pellets 45 include an insecticide composition.

The disclosure is not limited to the examples that are described above solely by way of an example but encompasses all the alternative aspects that a person skilled in the art could contemplate within the scope of the intended protection. For example, the openings 16 in the single facing walls around the housing of the box can be elongated openings as shown, but also can be round holes covering a significant part of these walls, and the cover can be a screw-on cover rather than a quarter-turn fastening cover. cm What is claimed is:

1. An insect pest detection system comprising:
a. a group of underground bait/trap boxes of the tubular box type provided with a housing provided with a first part, in the lower part of the box, for at least one edible mass comprising an edible material for said insects and provided with a device for detecting the consumption of said edible mass by said insects provided with measurement electronics comprising:
i. a device for measuring a first frequency on a first relaxation oscillator comprising a first measurement capacitor formed by two first electrode plates located on either side of said edible mass, said edible mass forming a dielectric material between said plates;
ii. a processor configured to take first measurements of the first frequency in accordance with a first schedule;
b. at least one concentrator module, the boxes of said group of boxes and said concentrator module each comprising first radio communication means configured to transmit said first measurements from said boxes to said concentrator in accordance with a second schedule;
c. at least one remote server, said concentrator module and said server each comprising second communication means configured to transmit said first measurements from the concentrator unit to the remote server in accordance with a third schedule, said remote server being provided with a monitoring program comprising computation means configured to measure frequency variations characteristic of a variation in density of the edible mass of at least one box of the group of boxes at least on the basis of a plurality of said first measurements, with said variation in density allowing the consumption of the edible mass by the insects to be detected.

2. The insect pest detection system according to claim 1, wherein at least some of the boxes of said group of boxes are provided with a compensation circuit comprising at least one second relaxation oscillator comprising a second measurement capacitor produced by second electrode plates disposed above the first plates, said measurement electronics and said processor being configured to carry out second measurements of the second frequency in accordance with a fourth schedule and to transmit said second measurements to said concentrator in accordance with a fifth schedule.

3. The insect pest detection system according to claim 2, wherein said fourth schedule is the same as the first schedule and/or the fifth schedule is the same as the second schedule.

4. The insect pest detection system according to claim 1, wherein said boxes are each provided with a device for managing periodic sleep phases and wake-up phases of their processor, said processor is configured to carry out, during its wake-up phases, the frequency measurements by means of the device for measuring said frequencies and to manage the establishment and the continuation of communication with the concentrator module and to transmit said measurements to said concentrator module, said concentrator module being configured to communicate with said boxes in order to periodically receive said first measurements from each box, to compile said measurements from all the boxes of the group of boxes and to transmit said compiled measurements to said remote server provided with said monitoring program and computation means, said computation means being configured to compute one or more variations in the frequency of the first oscillator for each box as a function of time so as to detect a characteristic variation in density of at least one of said edible masses on the basis of said variations.

5. A method for protecting a land surface, notably a land surface surrounding one or more buildings, by means of a detection system according to claim 1, comprising:
d. installing a concentrator module;
e. installing a group of bait/trap boxes in said surface each containing an edible mass of edible material for said insects;
f. pairing said concentrator with the server during a pairing step carried out for said concentrator;
g. pairing said one or more boxes with said concentrator during a pairing step carried out for each of said boxes;
h. setting the concentrator to listen to said configured boxes and to periodically send said concentrator, after sleep periods, the frequency measurements carried out by the measurement devices of said boxes;
i. transmitting, in accordance with the third schedule, the measurements of the plurality of boxes from the concentrator to said remote server;
j. the remote server computing the variations in the series of frequency data as a function of time for each box of said group and assessing the variation in density of the contents of the trap for at least one of said edible masses on the basis of said variations by detecting inflection points and/or changes in slope in said series of data.

6. The method according to claim 5, wherein the remote server processes the measurement data in order to detect the presence of said insects in a box via the detection of measurement oscillations resembling either consumption of the matrix or an addition of soil, or both.

7. The method according to claim 5, comprising the remote server computing a change in said variation in density and an algorithm for determining, on the basis of said change, whether said insects are present in at least one box in order to trigger an intervention in order to place a bait in said at least one box that comprises a lethal composition for said insect pest, or for determining, on the basis of said variation in density, the moment when said intervention is to be scheduled.

8. The method according to claim 5, wherein said remote server processes the measurement data in order to determine a rate of consumption of the edible masses for each box and to generate said intervention schedule for the plurality of boxes.

9. The method according to claim 5, wherein the boxes are configured to periodically transmit, in addition to the measurement data of the boxes, data frames comprising at least one data item from among:
i. a unique identifier of the box;
ii. a temperature of the box;
iii. a frequency measurement of the first relaxation oscillator;
iv. a frequency measurement of the second relaxation oscillator;
v. a date of the measurement.

10. The method according to any claim 5, wherein, with the boxes being provided with compensation circuits comprising at least one second relaxation oscillator comprising a second measurement capacitor produced by second plates disposed beyond the presence of said edible mass, said measurement electronics and said processors of said boxes being configured to carry out second measurements of the second frequency in accordance with a fourth schedule and to transmit said second measurements to said concentrator in accordance with said fourth schedule, the remote server is configured to assess the consumption of the edible masses by the insects on the basis of computations comprising computations of differential frequencies between the frequency of the first relaxation oscillator and of the second relaxation oscillator.

11. The method according to claim 10, wherein the computations of differential frequencies between the first and the second relaxation oscillator are of the following type:
$$F = ( {F}_{A} - {S}_{A} ) - [ ( {F}_{B} - {S}_{B} ) \times k ] ,$$
where:
F is the resulting differential frequency, after compensation;
F_{A}, F_{B} are the frequencies measured on the measurement capacitors A and B of the compensation circuit;
S_{A}, S_{B} are compensation offsets of the capacitors A and B;
k is a compensation constant that depends on the construction of the trap, the choice of materials and the size of the capacitor plates;
with this computation being carried out for a series of successive measurements carried out by each box.

12. The method according to claim 11, wherein the offsets correspond to a no-load capacitance of the two capacitors A and B and are measured during a device initialization step when installing a trap without edible mass so that FA0=SA and likewise FB0=SB.

13. The method according to claim 5, wherein the remote server is configured to record the measurements originating from the boxes and to form a measurement database forming a deep learning database for a neural network.

14. The method according to claim 13, wherein the remote server is configured to estimate the consumption of the edible masses using an artificial intelligence algorithm based on said neural network previously trained with said deep learning database for the frequency measurements.

15. The method according to claim 9, wherein the concentrator sends the server, in addition to the measurement data, data frames comprising at least one of the data items from among:
k. a reception level of the concentrator in dBm;
l. a version of the concentrator module software;
m. a version of the software for communicating from the concentrator module to the remote server;
n. an indication that the concentrator module is being paired;
o. a table including at least one of the following for each box:
i. a unique identifier of the box;
ii. a reception level of the radio signal between the box and the concentrator;
iii. a remaining battery level of the box as a %;
iv. a software version of the box;
v. one or more data items indicating whether the box is in pairing mode,
and wherein the remote server is configured to carry out a diagnostic, on the basis of the received data, of the operation of the communication means of the concentrator module, as well as to carry out a diagnostic of the battery of the box and the communication device of the box.

16. The method according to claim 5, wherein the server comprises a gathering device configured to gather the messages originating from boxes as transmitted by the concentrator modules, the method comprises implementing a processing process comprising generating a map, and/or a list and/or a table representing the distribution of boxes connected to a concentrator module for which the presence of insects has been detected and a web service and/or mobile application process adapted to allow said map, said list or said table to be consulted by users.

17. The method according to any claim 5, wherein the server comprises a database of interventions representing the locations of boxes and of concentrator modules in a region, the method comprises implementing a process for organizing a schedule of interventions on said boxes in said region by technicians monitoring said boxes and concentrator modules as a function of the progress of the consumption of said edible masses.

18. The method according to claim 16, comprising updating the database of interventions with the interventions that have been carried out.
